(19) United States
(12) Patent Application Publication
(10) Pub. No.: US 2019/0170490 A1
(43) Pub. Date: Jun. 6, 2019

(54) DEVICE FOR USE WITH LASER ALIGNMENT DEVICES

(71) Applicant: Luke Deane ETHEREDGE, Armstrong Creek, Victoria (AU)

(72) Inventor: Luke Deane ETHEREDGE, Armstrong Creek, Victoria (AU)

(21) Appl. No.: 16/324,253

(22) PCT Filed: Aug. 9, 2017
(86) PCT No.: PCT/AU2017/050839

§ 371 Date: Feb. 8, 2019

(30) Foreign Application Priority Data
Aug. 9, 2016 (AU) 2016903121

(51) Int. Cl. G01B 3/06; G01B 1/00

(52) U.S. Cl. CPC G01B 3/06; G01B 1/00

(57) ABSTRACT

A device for measuring the distance from a reference point to a laser light beam, the device having measurement intervals defined by indicia and being configured such that at least a section of the device is substantially opaque but able to transmit an amount of laser light such that the opaque section becomes illuminated at the location where the laser light is transmitted, whereby the distance between the reference point and the location of the section where the laser light is transmitted is visibly perceivable.

### FIELD OF THE INVENTION

The present invention relates to a device for use with laser alignment devices, the device being able to transmit an amount of laser light such that the distance between a reference point and the location of laser light transmission on the device is visibly perceivable. The device may be in the form of a ruler.

### BACKGROUND OF THE INVENTION

Measuring devices such as rulers are commonly used with laser alignment devices for the measuring of distances in applications such as building and construction. However, such rulers generally do not transmit laser light emitted by laser alignment devices and as such, taking measurements with such rulers can be cumbersome and/or inconvenient.

In this regard, visual inspection of the ruler can lead to inaccurate measurements because the user must view the incident light on the ruler from an angle that is offset from the direction of the laser light. Inaccuracies in measurements may be further exacerbated the greater the size and/or diffraction of the laser light and thus it would be beneficial to be able to visibly perceive where the centre of the laser light is striking the ruler.

With reference to FIG. 1, there is shown a prior art ruler 5 which is positioned in the path of a laser light emitted by a laser alignment device 10. The prior art ruler 5 is substantially opaque and does not allow transmission of the laser light. As such, the laser light is not visibly perceivable on the surface 15 of the ruler 5 easily visible, i.e. the surface on which the laser light is not incident. As such a user must visually estimate the alignment between indicia on the ruler and the centre of the beam.

Furthermore, if the laser light is aimed upwardly from a floor, and a prior art ruler is positioned relative to a reference point and in the path of the laser light, the distance between the reference point and the laser light is generally only ascertainable by visually inspecting the surface of the ruler on which the laser light is incident. This can be physically awkward because the user of the ruler must bend over and look upwardly at the surface of the ruler struck by the laser light.

Meanwhile, rulers which are substantially transparent are generally inconvenient, if not dangerous to use with laser light because the laser light can exit the ruler and potentially enter and damage the user's eye(s).

Examples of the present invention seek to solve, or at least ameliorate, one or more disadvantages of previous rulers for measuring the distance from a reference point to a laser light.

### SUMMARY OF THE INVENTION

In accordance with one aspect of the present invention, there is provided a device for measuring the distance from a reference point to a laser light beam, the device having measurement intervals defined by indicia and being configured such that at least a section of the device is substantially opaque but able to transmit an amount of laser light such that the opaque section becomes illuminated at the location where the laser light is transmitted, whereby the distance between the reference point and the location of the section where the laser light is transmitted is visibly perceivable.

Preferably, the device has a body with two opposed surfaces and configured such that said amount of transmitted laser light corresponds to the laser light that is incident on either of the opposed surfaces.

More preferably, for each of the opposed surfaces, the body is able to transmit laser light incident on the surface to cause illumination on the other opposed surface. Even more preferably, wherein said indicia is visible from either of the opposed surfaces. In one form, the measurement intervals are depicted to be read from observing either of said opposed surfaces.

Preferably, the body is formed of a transparent or translucent material.

In a preferred form, the body is moulded from a polymer.

Preferably, the indicia are formed on the opaque section.

Preferably, the opaque section is formed of a sheet. More preferably, the sheet is formed from a polymer or paper-based material.

The opaque section may be encapsulated within the body of the device.

Preferably, one or both of the two opposed surfaces comprises said opaque section.

In a preferred form, said opaque section appears substantially opaque when viewed under white light.

Preferably, the device is in the form of a straight ruler or folding ruler.

Preferably, the measurement intervals include numbers represented to be read from observing either of said opposed surfaces. More preferably, the numbers are represented on opposite sides of the body. The numbers may be represented on opposite sides of the sheet.

In a preferred form, the sheet is sandwiched between a pair of transparent and/or translucent parts.

Preferably, the opaque section is a section of paint.

In one form, at least one edge of the device is a bevelled edge.

Preferably, the device includes a pair of parts coupled by a pivot for pivotal movement of the first part relative to the second part.

Preferably, the device has a thickness of between 3 mm and 7 mm. More preferably, the device has a thickness of 5 mm.

In accordance with another aspect of the present invention, there is provided a system for checking alignment of a building component, wherein the system includes a laser light emitter and a device for measuring as defined in any one of the preceding claims, and wherein the device for measuring is used to measuring the distance from a reference point on the building component to a laser light beam emitted from the laser light beam emitter.

In accordance with another aspect of the present invention, there is provided a method of checking alignment of a building component including the steps of:
using a system as described above to measure a distance from a first reference point on the building component to a laser light beam emitted from the laser light beam emitter to determine a first measurement;
using the system to measure a distance from a second reference point on the building component to the laser light beam to determine a second measurement; and
comparing the second measurement to the first measurement.

In accordance with another aspect of the present invention, there is provided a method of measuring the distance from a reference point to a laser light beam, including the steps of:
positioning a device relative to the reference point and the laser light beam, the device having measurement intervals defined by indicia and being configured to transmit an amount of laser light such that the device becomes illuminated at the location where the laser light is transmitted, whereby the distance between the reference point and the location of the section where the laser light is transmitted is visibly perceivable; and
determining, with reference to the indicia, the distance between the reference point and the laser light beam.

Preferably, at least a section of the device is substantially opaque but able to transmit an amount of laser light, the opaque section configured to become illuminated at the location where the laser light is transmitted.

Preferably, positioning the device includes bringing one end of the device into abutment or overlapping relation with the reference point and arranging the device so that the laser light beam passes through the device.

### BRIEF DESCRIPTION OF THE DRAWINGS

Preferred embodiments of the invention will be further described, by way of non-limiting example only, with reference to the accompanying drawings in which:

FIG. 1 is a plan view of a prior art ruler positioned in the path of a laser light, the laser light not being transmitted through the prior art ruler;

FIG. 2 is a plan view of a device of an embodiment of the invention, the device being positioned in the path of a laser light and transmitting an amount of the laser light;

FIG. 3 is a perspective side view of the device of FIG. 2;

FIG. 4 is a plan view of a system of an example of the present invention, including a laser light emitter and a device for measuring; and

FIG. 5 is a perspective view of the system of FIG. 4.

### DETAILED DESCRIPTION

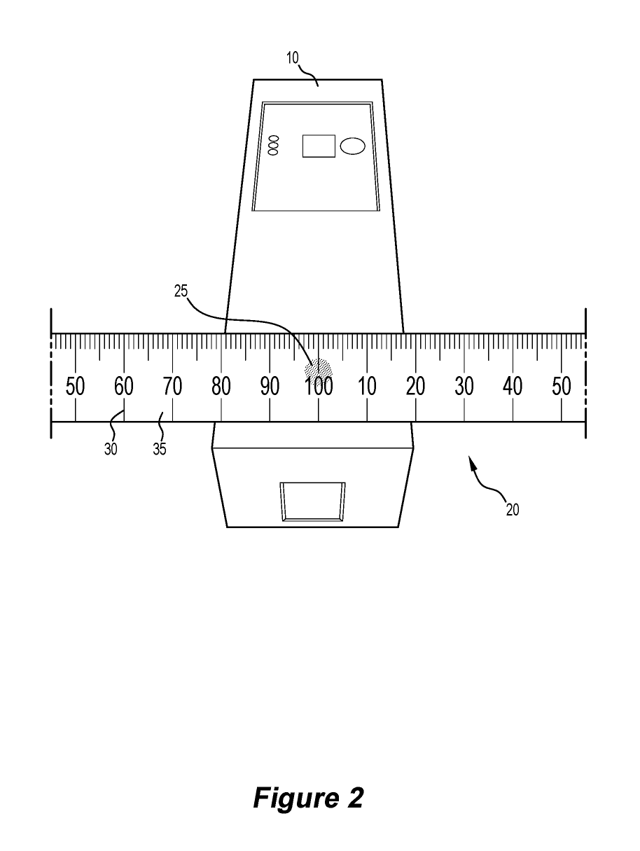

FIG. 2 illustrates a device 20 according to a preferred embodiment of the present invention. The device 20 is configured for measuring the distance from a reference point to a laser light beam.

The device 20 comprises measurement intervals defined by indicia 30. The indicia 30 indicate distance intervals via which distance measurements can be made which, in the depicted embodiment, is a decimal measurement scale, though it will be appreciated that the indicial may take other forms, such as imperial measurements or simple indications or a particular length. The device 20 is configured such that at least a section 35 of the device 20 is substantially opaque, but able to transmit an amount of laser light 25.

The term opaque will be generally understood to mean not transparent or able to be seen through and it will be appreciated that embodiments that are not entirely opaque are still possible and will still obtain the desired result.

The opaque section 35 of the device 20 can be illuminated at the location where the laser light 25 is transmitted, and the distance between a reference point (i.e. a point from which a distance measurement is desired) and the location of the section 35 where the laser light 25 is transmitted is visibly perceivable. As such, the device 25 can be positioned in the path of an upwardly directed laser light 25, and an amount of laser light 25 can be transmitted through the device 20 such that the laser light 25 is visibly perceivable on an upper surface of the device 20, i.e. the surface of the device 20 opposite to that on which the laser light is incident, thereby allowing a user to measure a distance from the reference point to the laser light 25 without needing to inspect the surface of the device 25 upon which the laser light 25 is incident.

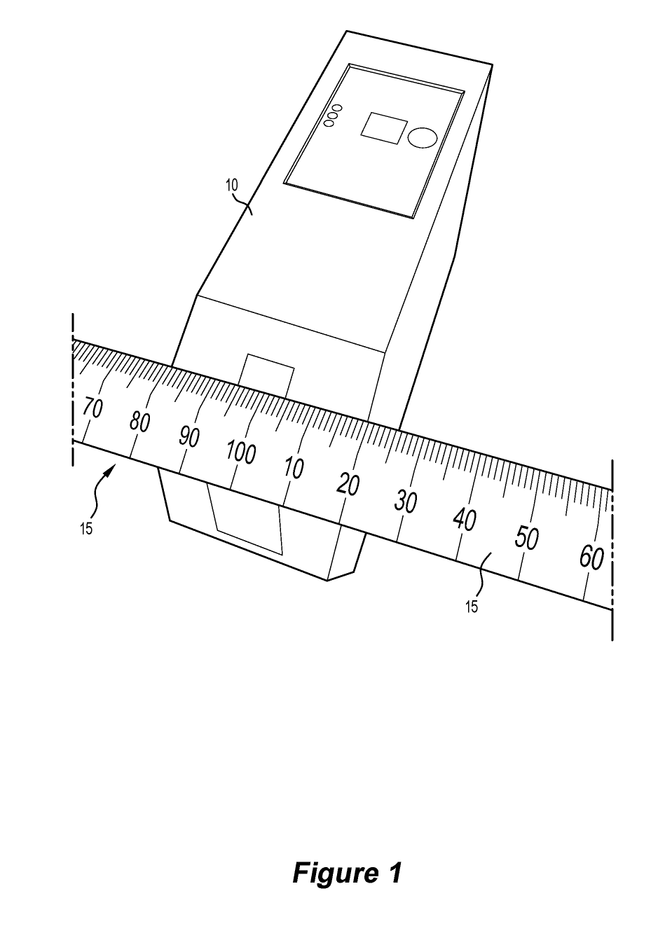

In contrast to the prior art ruler 5 of FIG. 1, devices 20 embodying the present invention are able to transmit an amount of the laser light 25 such that the laser light 25 is visibly perceivable on a surface of the device 20 on which the laser light 25 is not incident, thereby simplifying and improving the accuracy of measurements taken.

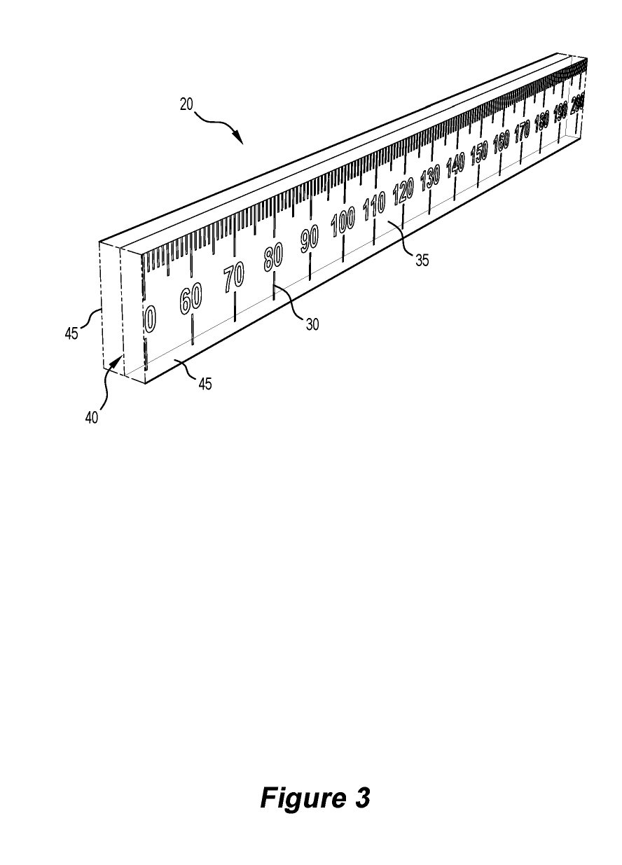

With reference to FIG. 3, the device 20 comprises a body 40 having two opposed surfaces 45. The device 20 is configured such that in use, the amount of laser light 25 that is transmitted through the device 20 corresponds to the laser light that is incident on either of the opposed surfaces 45. In the depicted embodiment, the body 40 of the device 20 is formed of a transparent or translucent material such as polymer. For example, it is envisaged that the device 20 can be moulded from material including resin.

As can be seen from FIGS. 2 and 3, the indicia 30 are formed on the opaque section 35 of the device 20. The opaque section 35 can be formed of a sheet or film, such as a sheet made from polymer or a paper-based material, such as cardboard. In the depicted embodiment, the opaque section 35 is formed from a sheet of paper 35 which is encapsulated within the body 40 of the device 20. Although the opaque section extends across the width and length of the device 20, it will be appreciated that only a part of the device may be so configured, such as for example only along a single edge where indicia are disposed.

It is also envisaged that the transparent or translucent body 40 of the device 20 can be coated in a material such as paint such that the device 20 appears opaque under white light. In such an embodiment, the coated exterior of the device 20 may have the indicia 30 applied thereto to moulded within the body 40 so that an amount of laser light 25 incident on either opaque opposed surface 45 will also be visibly perceivable on the other opposed surface 45.

While the figures depict the device 20 as a straight ruler, it is also envisaged that the device 20 can comprise a folding ruler.

In use, the device 20 can be positioned relative to a reference point and in the path of the laser light 25 emitted from a laser alignment device 10. The distance between the reference point and the laser light 25 can thus be determined by visually inspecting the indicia 30 at the location the laser light 25 illuminates the device 20. This can allow for more convenient and more accurate measurements.

Advantageously, for each of the opposed surfaces 45, the body 40 is able to transmit laser light 25 incident on the surface to cause illumination on the other opposed surface. In the example depicted in FIG. 3 of the drawings, this is achieved by virtue of having the opaque section 35 sandwiched between portions of the body 40, such that either portion of the body 40 is able to transmit the laser light to the opaque section 35. Accordingly, the sheet is sandwiched between a pair of transparent and/or translucent body parts. Also, in the example shown, either portion of the body 40 is also able to allow vision of a user to the illuminated part of the opaque section when illuminated by the laser light applied to an opposite side (far side) of the opaque section 35. Furthermore, the indicia 30 is visible from either of the opposed surfaces, and this may be achieved by representing the indicia on opposite sides of the sheet, or more specifically, by printing the indicia on both opposed faces of the opaque section 35. The measurement intervals may be depicted to be read from observing either of said opposed surfaces and this may similarly be achieved by printing the measurement intervals on both opposed faces of the opaque section 35. In this way, the measurement intervals may include numbers represented to be read from observing either of said opposed surfaces.

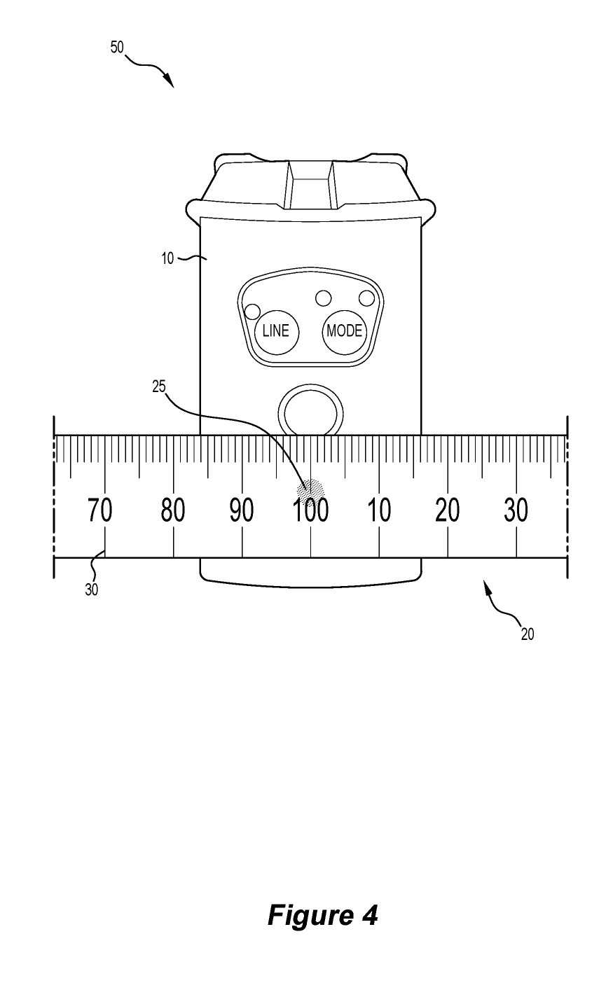

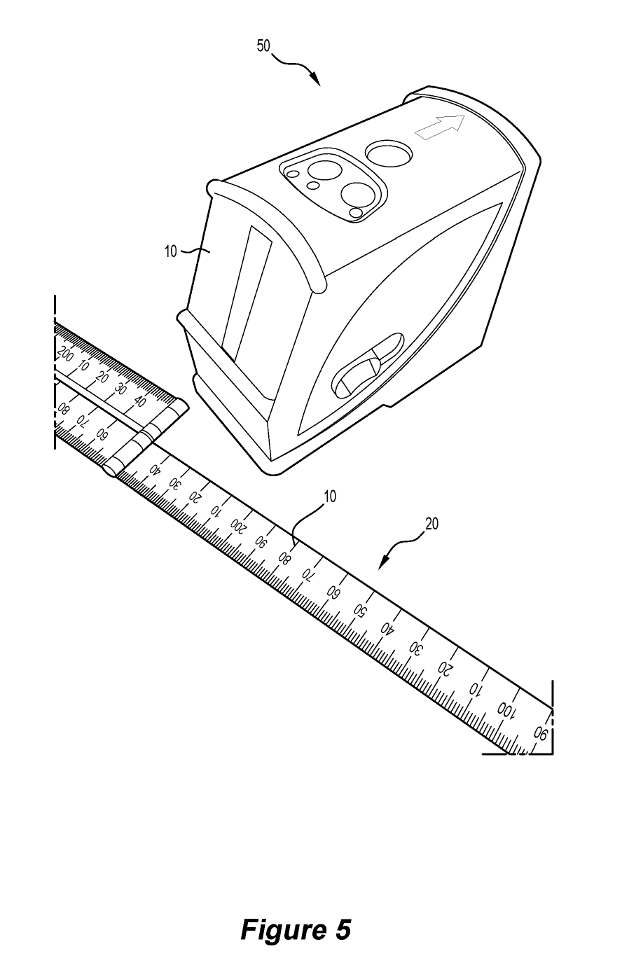

In an alternative example, the numbers may be represented on opposite sides of the body. Although the example depicted in FIG. 3 shows the opaque section in the form of a sandwiched sheet of opaque material, in an alternative example the opaque section may be in the form of a section of paint. FIGS. 4 and 5 show a system 50 including a laser emitter in the form of a laser alignment device 10 and a device 20 for measuring. The device 20 shown in FIGS. 4 and 5 is generally similar to the device 20 shown in FIGS. 2 and 3, and like features are indicated with like reference numerals.

The system 50 is for checking alignment of a building component, for example to check correct vertical alignment of a window or wall panel. The system 50 includes a laser light emitter in the form of a laser alignment device 10 and a device 20 for measuring. The device 20 for measuring is used to measuring the distance from a reference point on the building component to a laser light beam emitted from the laser light emitter.

There is also disclosed a method of checking alignment of a building component including the steps of: using a system 50 as described above to measure a distance from a first reference point on the building component to a laser light beam emitted from the laser light beam emitter to determine a first measurement; using the system to measure a distance from a second reference point on the building component to the laser light beam to determine a second measurement; and comparing the second measurement to the first measurement. In one example, the laser light emitter emits a laser light beam which is automatically oriented to be vertical such that the building component is also able to be oriented vertically by using the laser light as a reference, using this method.

The device 20 for measuring may have a thickness of between 3 mm and 7 mm. More preferably, the device 20 may have a thickness of 5 mm. Although in the view shown in FIG. 3 the device 20 has flat opposed elongated edges, in an alternative example at least one edge of the device 20 may be a bevelled edge in a similar manner to the ruler shown in FIG. 1. Also, with reference to FIG. 5, the device 20 may include a pair of parts coupled by a pivot for pivotal movement of the first part relative to the second part. The device 20 may also have a plurality of parts coupled together by a plurality of hinges. For example, the device may have four parts connected in series by a lateral hinge, a central planar hinge, and a further lateral hinge in a configuration known as a “folding ruler” or “folding rule”.

The embodiments have been described by way of example only and modifications are possible within the scope of the invention disclosed.

1. A device for measuring the distance from a reference point to a laser light beam, the device having measurement intervals defined by indicia and being configured such that at least a section of the device is substantially opaque but able to transmit an amount of laser light such that the opaque section becomes illuminated at the location where the laser light is transmitted, whereby the distance between the reference point and the location of the section where the laser light is transmitted is visibly perceivable.

2. The device according to claim 1, having a body with two opposed surfaces and configured such that said amount of transmitted laser light corresponds to the laser light that is incident on either of the opposed surfaces.

3. The device according to claim 2, wherein for each of the opposed surfaces, the body is able to transmit laser light incident on the surface to cause illumination on the other opposed surface.

4. The device according to claim 3, wherein said indicia is visible from either of the opposed surfaces.

5. The device according to claim 4, wherein the measurement intervals are depicted to be read from observing either of said opposed surfaces.

6. The device according to claim 2, wherein the body is formed of a transparent or translucent material.

7. The device according to claim 2, wherein the body is moulded from a polymer.

8. The device according to claim 1, wherein the indicia are formed on the opaque section.

9. The device according to claim 1, wherein the opaque section is formed of a sheet.

10. The device according to claim 9, wherein the sheet is formed from a polymer or paper-based material.

11. The device according to claim 2, wherein the opaque section is encapsulated within the body of the device.

12. The device according to claim 2, wherein one or both of the two opposed surfaces comprises said opaque section.

13. The device according to claim 1, wherein said opaque section appears substantially opaque when viewed under white light.

14. The device according to claim 1, in the form of a straight ruler or folding ruler.

15. The device as claimed in claim 5, wherein the measurement intervals include numbers represented to be read from observing either of said opposed surfaces.

16. The device as claimed in claim 15, wherein the numbers are represented on opposite sides of the body.

17. The device as claimed in claim 15, wherein the numbers are represented on opposite sides of the sheet.

18. The device as claimed in claim 9, wherein the sheet is sandwiched between a pair of transparent and/or translucent parts.

19. The device as claimed in claim 1, wherein the opaque section is a section of paint.

20. The device as claimed in claim 1, wherein at least one edge of the device is a bevelled edge.

21. The device as claimed in claim 1, wherein the device includes a pair of parts coupled by a pivot for pivotal movement of the first part relative to the second part.

22. The device as claimed in claim 1, wherein the device has a thickness of between 3 mm and 7 mm.

23. The device as claimed in claim 22, wherein the device has a thickness of 5 mm.

24. A system for checking alignment of a building component, wherein the system includes a laser light emitter and a device for measuring as defined in any one of the preceding claims, and wherein the device for measuring is used to measuring the distance from a reference point on the building component to a laser light beam emitted from the laser light beam emitter.

25. A method of checking alignment of a building component including the steps of:
using a system as defined in claim 24 to measure a distance from a first reference point on the building component to a laser light beam emitted from the laser light beam emitter to determine a first measurement;
using the system to measure a distance from a second reference point on the building component to the laser light beam to determine a second measurement; and
comparing the second measurement to the first measurement.

26. A method of measuring the distance from a reference point to a laser light beam, including the steps of:
positioning a device relative to the reference point and the laser light beam, the device having measurement intervals defined by indicia and being configured to transmit an amount of laser light such that the device becomes illuminated at the location where the laser light is transmitted, whereby the distance between the reference point and the location of the section where the laser light is transmitted is visibly perceivable; and
determining, with reference to the indicia, the distance between the reference point and the laser light beam.

27. The method according to claim 26, wherein at least a section of the device is substantially opaque but able to transmit an amount of laser light, the opaque section configured to become illuminated at the location where the laser light is transmitted.

28. The method according to claim 26, wherein positioning the device includes bringing one end of the device into abutment or overlapping relation with the reference point and arranging the device so that the laser light beam passes through the device.
